(19) United States
(12) Patent Application Publication
(10) Pub. No.: US 2026/0164199 A1
(43) Pub. Date: Jun. 11, 2026

(54) AUTOMATIC DETECTION OF SPEAKER TYPE

(71) Applicant: HARMAN BECKER AUTOMOTIVE SYSTEMS GmbH, Karlsbad-Ittersbach (DE)

(72) Inventors: Fanyu MENG, Oberschleissheim (DE); Adrian VON DEM KNESEBECK, Munich (DE); Christopher OATES, Bamberg (DE); Friedrich VON TÜRCKHEIM, Hamburg (DE)

(21) Appl. No.: 19/179,364

(22) Filed: Apr. 15, 2025

(30) Foreign Application Priority Data
May 22, 2024 (EP) 24177450.4

(51) Int. Cl. H04R 29/00; H04R 1/26; H04R 3/14

(52) U.S. Cl. CPC H04R 29/002; H04R 1/26; H04R 3/14; H04R 2499/13

(57) ABSTRACT

Disclosed are techniques for determining a sound signal response detected by an acoustic detector placed at a defined position within an operating environment where a sound system with a plurality of loudspeakers is located, wherein the sound signal response is based a test sound signal output by each of the loudspeakers and detected by the acoustic detector. For each of the loudspeakers, an operating frequency range is determined based on the detected sound signal response and a speaker type is assigned to each of the loudspeakers based on the determined operating frequency range. For each of the loudspeakers, a location in the operating environment is provided and a grouping for each of the loudspeakers, by which each loudspeaker is grouped into one of several speaker groups based on the provided position and the speaker type of the corresponding loudspeaker. The determined grouping is provided for further tuning the sound system.

### CROSS-REFERENCE TO RELATED APPLICATIONS

This application claims priority benefit of Application No. EP24177450.4, titled “AUTOMATIC DETECTION OF SPEAKER TYPE,” and filed May 22, 2024. The subject matter of this related application is hereby incorporated by reference herein in its entirety.

### BACKGROUND

### Field of the Various Embodiments

The application relates to a computer implemented carried out at a control entity for a plurality of loudspeakers, and to the corresponding control entity, a computer program comprising program code and a carrier comprising the computer program.

### Description of the Related Art

In the fields of studios, home theaters and automotive audio systems, it is important to know the speaker type, e.g. subwoofer, woofer, midrange or tweeter, to play signals in the allowed frequency range, either for acoustic measurements, sound tuning or music playback. There is a risk if the playback signal contains frequency content that is beyond the working frequency range of the speaker, to cause permanent damage. For example, a tweeter might be damaged if sound with frequency that is lower than the tweeter's limit is played. Another benefit of detecting the speaker type is to properly group speakers for sound tuning.

Speaker type detection is manual and repetitive work. One way is to directly check the manufacturer's information on the speaker. However, technical specifications, such as the frequency range, are not always available. This information is even more difficult in vehicles, where the speakers are well embedded into the car's interior and accessing them is a time-consuming process which may even damage the enclosure of the speakers and hence should be avoided. Another way is to perform measurements to detect the speaker's frequency range. This process is usually manual, and repetitive when there are multiple speakers, such as in a vehicle, where the number of speakers can go up to 30. For the situation of speakers mounting in cars, it is again almost impossible to remove them and perform frequency measurements in controlled lab environments, such as anechoic chambers. Therefore, a system and method that can automatically detect and improve speaker type detection in-situ is needed to accelerate acoustic measurements and sound tuning.

### SUMMARY

This need is met by the features of the independent claims Further aspects are described in the dependent claims.

According to a first aspect a computer implemented method carried out at a control entity for a plurality of loudspeakers of a sound system located in an operating environment is provided, wherein the method comprises steps of determining a sound signal response detected by an acoustic detector placed in a defined position within the operating environment where the sound system with a plurality of loudspeakers is located, wherein the sound signal response is based on a test sound signal output by each of the loudspeakers and detected for each of the plurality of loudspeakers. Furthermore, an operating frequency range is determined for each of the plurality of loudspeakers based on the detected sound signal response and a speaker type is assigned to each of the loudspeakers based on the determined operating frequency range. For each of the loudspeakers a location in the operating environment is provided and a grouping is determined for each of the loudspeakers by which each of the loudspeakers is grouped into one of several speaker groups based on the provided position and the determined speaker type of the corresponding loudspeaker. Furthermore, the determined grouping is provided for the further tuning of the sound system.

Furthermore, the corresponding control entity configured to determine the audio speaker profiles is provided which is configured to operate as discussed above or as discussed in further detail below.

In addition, a computer program comprising program code is provided to be executed by at least one processing unit of a control entity wherein execution of the program code causes the at least one processing unit to carry out a method as discussed above or as discussed in detail below.

Finally, a carrier is provided comprising the computer program, wherein the carrier is one of an electronic signal optical signal, radio signal, and computer-readable storage medium.

At least one advantage of the disclosed techniques relative to the art is that an automated reliable, error reduced and accelerated in situ way is provided for correctly determining a speaker type in an environment where the speakers are actually used. The grouping of the speakers into different speaker groups helps to improve the sound impression in the environment where the speaker group is used and the grouping can be used for further tuning the sound system.

### BRIEF DESCRIPTION OF THE DRAWINGS

So that the manner in which the above recited features of the different embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way and there are other equally effective embodiments.

FIG. 1 is a schematic architectural view of a system which is configured to determine a speaker type and a grouping for a sound system.

FIG. 2 shows a schematic view of a sound system in a vehicle with a distribution of loudspeakers for the speaker type and the grouping has to be carried out.

FIG. 3 shows a schematic view of the system of FIG. 2 in which a speaker type has already been assigned to two of the loudspeakers.

FIG. 4 shows a schematic view of the system of FIGS. 2 and 3 where the speaker type is determined one by one for each of the loudspeakers of the sound system.

FIG. 5 shows the system of FIG. 2 where all speaker types have been detected.

FIG. 6 shows a schematic view of a speaker grouping of the system shown in FIGS. 2-5.

FIG. 7 shows an example flowchart of a method carried out by a control entity configured to determine the speaker type and the grouping of the speakers.

FIG. 8 shows an example schematic representation of a control entity configured to determine a speaker type and a grouping for the speakers in the environment wherein the loudspeaker system is used.

### DETAILED DESCRIPTION

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

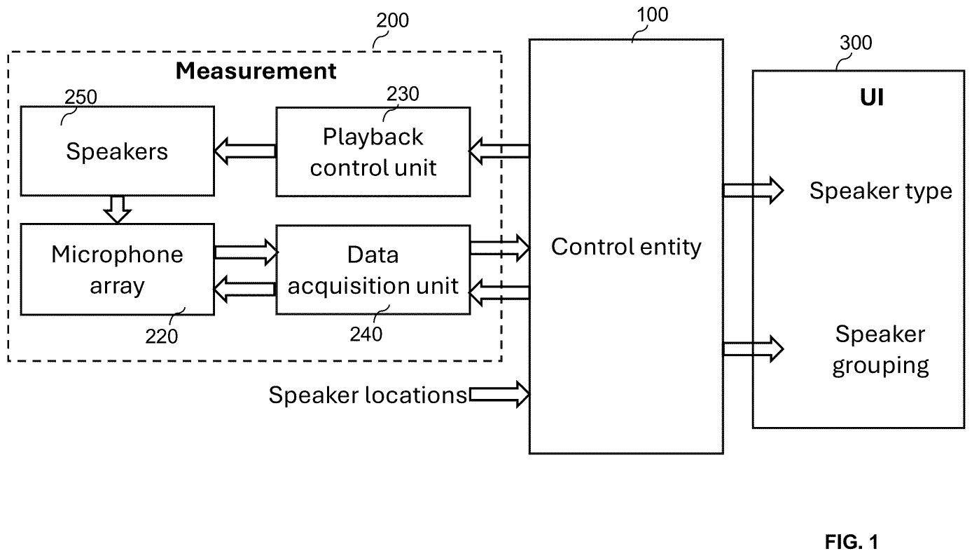

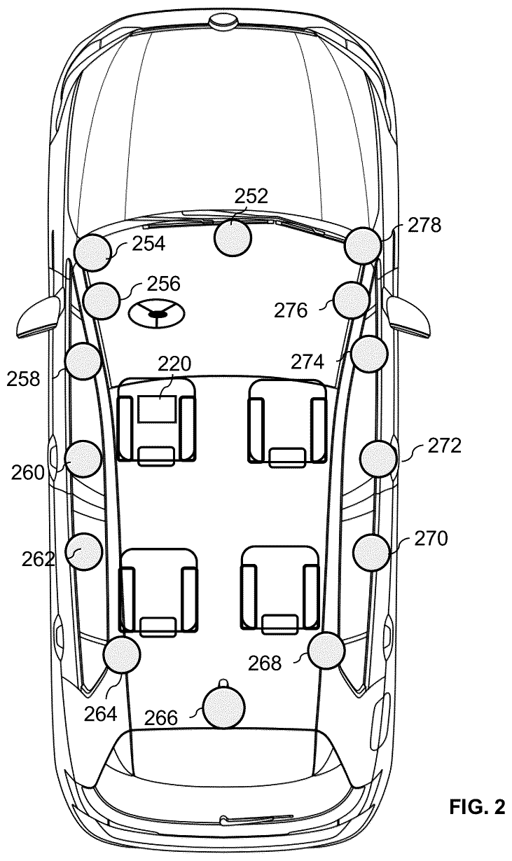

FIG. 1 is a conceptual illustration of a system configured to implement one or more aspects of the present application. The system includes a control entity 100 configured to determine a speaker type for an audio system comprising a plurality of loudspeakers which is shown in more detail in FIGS. 2-5. The system furthermore comprises a measurement module 200 and a user interface 300. The measurement module 200 comprises the plurality of loudspeakers 210 of the audio system, an acoustic detector which can be implemented as one microphone or as microphone array 220 with several microphones configured to record the sound played by the speakers 210, a playback control unit 230 which controls the speakers and receives control messages and data from the control entity. Data acquisition unit 240 receives data and control messages from the control entity 100 and controls the microphone array 220. The control entity 100 sends information to the playback control unit 230 such as the used stimulus signals, output gain, sequence of speakers etc. Furthermore, control entity 100 processes and analyses the measurement data to determining the maximum sound pressure level, SPL, of the full frequency range and determines an operating or working frequency range for each of the loudspeakers and assigns a type to each of the loudspeakers under test. Furthermore, the control entity 100 provides a suggestion of a grouping for the speakers using inter alia the information of the speaker locations provided to the control entity 100 and the determined speaker type.

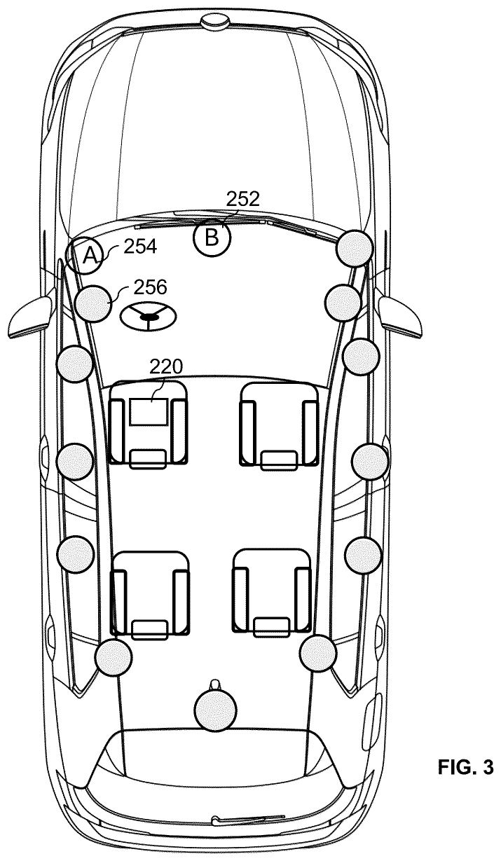

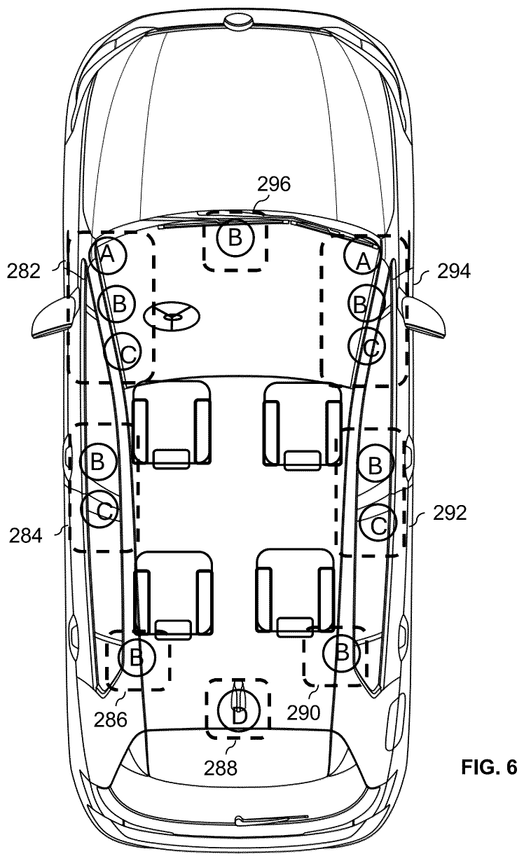

Using the user interface, UI, 300 a user of the system can position speakers according to their location to a vehicle interior layout such as shown in FIG. 2. The user interface may display a speaker layout overlying with the car interior as shown in FIG. 2, it can display a microphone array location such as on the driver or passenger seat, it can display the determined speaker type once it has been detected as shown in FIGS. 3-5. Furthermore, the user interface may display a speaker grouping after all type information is obtained as shown in connection with FIG. 6.

As shown in FIG. 2 where the speakers 252-278 are placed in the vehicle interior layout according to their registered locations. The microphone array 220 is placed on one of the seats for recording and a test sound signal is output one after the other by each of the speakers 252-278. By way of example, a total harmonic distortion, THD measurement can be performed through all the speakers. The working frequency range for each of the speakers can be calculated from the THD measurement results in the control entity 100. By setting a threshold below the maximum level that the THD measurements reach, the working frequency range can be determined. A table of speaker types and frequency ranges can be provided and by checking the highest overlapping ratio, a speaker type can be automatically assigned to each of the speakers 252 to 278 on the test. In the situation shown in FIG. 2 the speaker type has not yet been determined for any of the speakers.

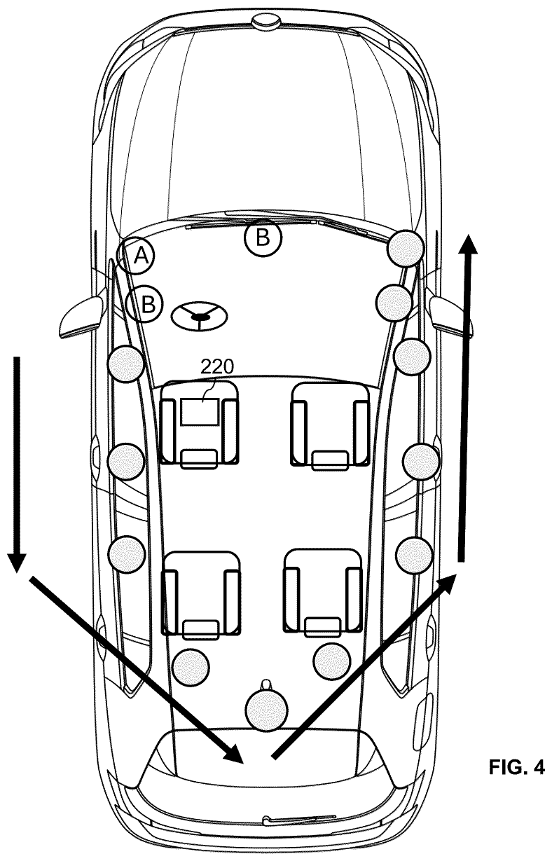

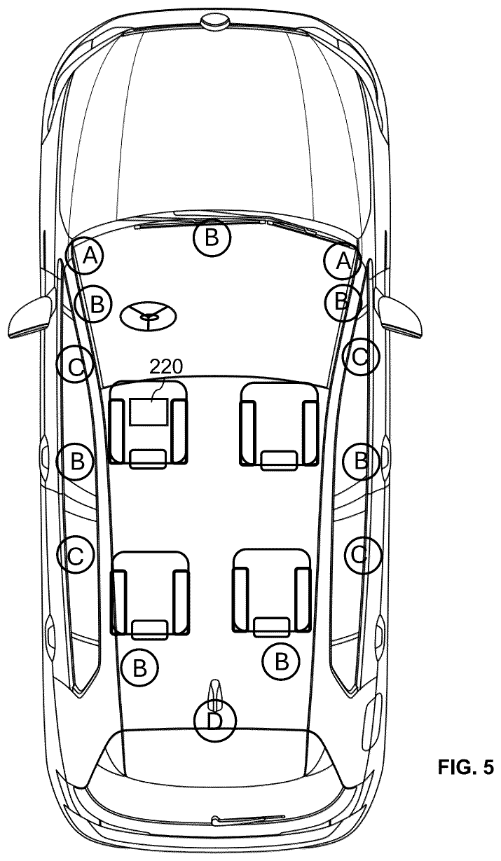

Referring also to FIG. 3 a visual representation can be added when the corresponding speaker type has been determined. The speaker type representation can include visual representations as known for the different speaker types such as a tweeter, a mid-range speaker, a woofer, a subwoofer or a full range speaker. For the sake of clarity, characters are used in the present situation where the character A represents the tweeter speaker, B the midrange speaker, C a woofer speaker, and D a subwoofer speaker. In the situation shown in FIG. 3 the speaker type has already been determined for speakers 252 and 254, namely for speaker 252 a midrange frequency type and speaker 254 a tweeter. As shown in FIG. 4 by the arrows, the speaker type determination can be carried out one by one for all of the speakers in the environment resulting finally in a situation shown in FIG. 5 where the speaker type has been determined for each of the speakers of the audio system wherein the involved speaker types in the example shown include speaker types from tweeter to subwoofer as symbolized by the characters A-D.

Referring now to FIG. 6 it is then possible to determine a grouping of the speakers given the speaker location and the speaker type information. As shown in FIG. 6 the loudspeakers can be grouped together in the example shown a first group 282 includes a woofer, a mid-range and a tweeter speaker that covers a broad frequency band and which are located close to each other. A second group 284 is determined located closer to a head of a passenger which includes a mid-range and a woofer, wherein the same kind of grouping is determined for the passenger seat in group 292 and 294. In the rear part of the vehicle a rear left group 286 a rear right group 290 and a subwoofer 288 is generated, wherein similar to the driver's seat a group 294 is generated comprising a tweeter, mid-range and woofer.

In the example shown in FIG. 6, eight groups are created such as front centre 296, front left 282, front right 294, rear left 284 the rear right group 292. Finally, the surround left 286, the surround right 290 and the subwoofer 288.

It should be understood that this is only an example grouping and other groupings might be generated with each group covering different frequency ranges and each group including one or several of the speakers provided in the operating environment, here a vehicle cabin.

With the speaker type and the working frequency range the playback frequencies can be controlled within the limits to protect the speakers.

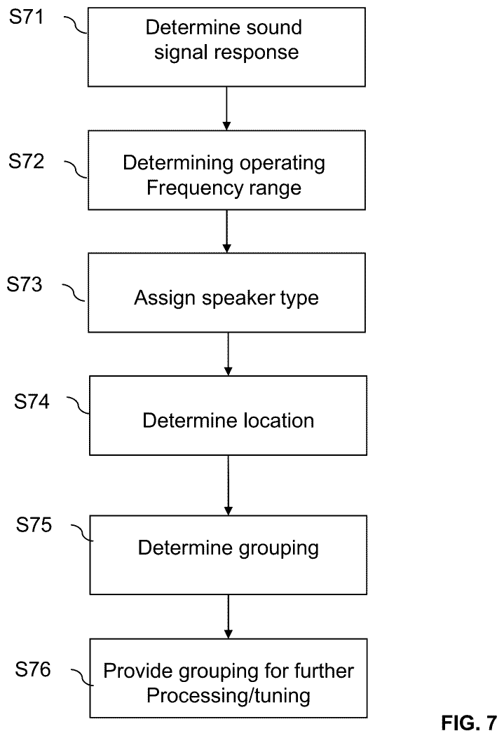

FIG. 7 shows a schematic view of some of the steps carried out in the method described above. In step S71 a sound signal response is determined by the control entity which was detected by the microphone array or acoustic detector placed within a defined position such as one of the seats in a vehicle. This sound signal response is determined individually for each of the speakers based on a test sound signal output by the corresponding speaker. In step S72 the speakers'operating frequency ranges are determined based on the detected sound signal response and in step S73 a speaker type is assigned to each of the speakers such as the speaker type treater, mid-range, woofer, subwoofer, or full range. However, it should be understood that any other speaker types might be used. Furthermore, in step S74 the location is determined in which the corresponding speaker is used and based on the location and the speaker type a grouping is determined for each of the loudspeakers in step S75 and as discussed above in connection with FIG. 6. In step S76 the grouping is provided for the further processing and for the fine-tuning. Here it is possible to determine a face information for the different groups. Furthermore, the tuning can include the generation of a three-dimensional sound field for the speaker system Within a group it is then possible to align the level of the speakers towards a defined target for a balanced perception between speakers. Furthermore, it is possible to assign the same delay and gain values to speaker of the same group when it comes to inter-group time and level alignments, which also aim to control a perceived location of the sound.

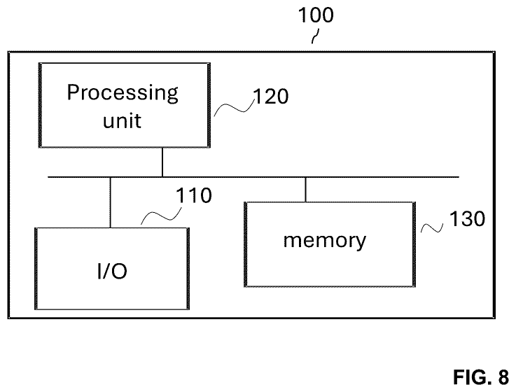

FIG. 8 shows a schematic architectural view of the control entity 100 which can carry out the above discussed processing such as the processing shown in FIG. 7. The control entity 100 comprises an interface 110 configured to receive control messages and audio data from other entities and configured to transmit control messages and audio data to other entities. The interface may be especially qualified to receive the detected sound signal responses as received by the microphone array from the different loudspeakers. The control entity 100 furthermore comprises a processing unit 120 which is responsible for the operation of the control entity 100. The processing unit 120 can include one or more processors and can carry out instructions stored on a memory 130, wherein the memory may include a read-only memory, a random access memory, a mass storage, a hard disk or the like. The memory 130 can furthermore include suitable program code to be executed by the processing unit 120 so as to implement the above-described functionalities in which the control entity is involved.

From the above said some general conclusions can be drawn:

When detecting the sound signal responses for the loudspeakers it is possible that the sound signal response is determined for each of the loudspeakers separately with the test sound signal being output by only one of the plurality of loudspeakers and detected by the acoustic detectors.

Furthermore, the grouping of the loudspeakers may be determined such that the loudspeakers arranged relative to each other within a predefined distance in the operating environment are grouped into the same speaker group. Furthermore. it is possible that the grouping is determined such that the loudspeakers belonging to the same speaker group together cover a defined frequency range which is broader than the operating frequency range of one of the loudspeakers present in the speaker group. As shown in FIG. 6 different speakers of different speaker types may be grouped together in order to have an audio signal covering a broad frequency range coming from a certain location.

The grouping may be determined such that the loudspeakers of a different speaker type are placed in the same speaker group.

Detecting the sound signal can include the step of determining a total harmonic distortion, THD signal and the operating frequency is determined from the THD signal. The THD measurement leads to a SPL signal in dB plotted over frequency, and a signal part higher than a threshold value (e.g. 100 dB or any other value) is present over a certain frequency range. This frequency range having a signal level higher than a threshold is then compared to predefined frequency ranges known for the different types of speakers such was subwoofer, woofer, midrange or Tweeter. The type of the predefined frequency types having the highest overlap with the THD signal then determines the operating frequency.

When the determined grouping is provided for the further processing, it is possible that the grouping is used to control a phase of the audio input signal which is input into the loudspeakers of one group.

The control entity and the loudspeakers may be located in a vehicle and the operating environment is the vehicle cabin. However it should be understood that any other operating environment may be used where the loudspeakers cannot be easily removed for test purposes.

For assigning the speaker type it is possible to compare the determined operating frequency to a lookup table in which the speaker type is indicated in dependence on an operating frequency range. Here the lookup table can include a predefined frequency range for each speaker type and the speaker type is assigned based on the highest overlap between each of the predefined frequency ranges and the determined operating frequency range.

The techniques discussed above provide an in-situ measurement without removing speakers and measuring in controlled lab environments. It allows an automatic detection of a speaker working frequency range and types so that manual and repetitive manual work which is also error prone is avoided. It guarantees a safe operating frequency range for the speakers, an efficient grouping of speakers for the sound tuning with the type information and provides an intuitive user interface for visualizing the detected speaker types and groups.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer implemented method comprising, at a control entity:
determining a sound signal response detected by an acoustic detector placed at a defined position within an operating environment where a sound system with a plurality of loudspeakers is located, wherein the sound signal response is based on a test sound signal output by each of the loudspeakers and detected for each of the plurality of loudspeakers,
determining, for each of the loudspeakers, an operating frequency range based on the detected sound signal response,
assigning a speaker type to each of the loudspeakers based on the determined operating frequency range,
providing, for each of the loudspeakers, a location in the operating environment,
determining a grouping for each of the loudspeakers, by which each loudspeaker is grouped into one of several speaker groups based on the provided location and the speaker type of a corresponding loudspeaker, and
providing the determined grouping for further tuning the sound system.

2. The computer implemented method of claim 1, wherein the sound signal response is determined for each of the loudspeakers separately with the test sound signal being output by only one of the plurality of loudspeakers and detected by the acoustic detector.

3. The computer implemented method of claim 1, wherein the grouping of the loudspeakers is determined such that the loudspeakers arranged relative to each other within a predefined distance in the operating environment are grouped into a same speaker group.

4. The computer implemented method of claim 1, wherein the grouping of the loudspeakers is determined such that the loudspeakers belonging to a same speaker group together cover a defined frequency range broader than the operating frequency range of one of the loudspeakers present in the same speaker group.

5. The computer implemented method of claim 1, wherein the grouping of the loudspeakers is determined such that loudspeakers of a different speaker type are placed in a same speaker group.

6. The computer implemented method of claim 1, wherein determining the sound signal response comprises determining a total harmonic distortion (THD) signal, wherein the operating frequency range is determined from the THD signal.

7. The computer implemented method of claim 1, wherein providing the determined grouping comprises at least one of the following:
using the grouping for controlling a phase of at least one input audio signal input into all loudspeakers of one group, or
using the grouping for generating a 3-dimensional sound field based on the plurality of loudspeakers.

8. The computer implemented method of claim 1, wherein the control entity is located in a vehicle and the operating environment is a cabin of the vehicle.

9. The computer implemented method of claim 1, wherein assigning the speaker type comprises comparing the determined operating frequency range to a look up table in which the speaker type is indicated in dependence on the operating frequency range.

10. The computer implemented method of claim 9, wherein the look up table comprises a predefined frequency range for each speaker type, wherein the speaker type is assigned based on a highest overlap between predefined frequency ranges in the look up table and the determined operating frequency range.

11. A system comprising:
a memory and at least one processing unit, the memory containing instructions executable by the at least one processing unit, wherein the processing unit executes the instructions to perform the steps of:
determining a sound signal response detected by acoustic detectors placed at a defined position within an operating environment where a sound system with a plurality of loudspeakers is located, wherein the sound signal response is based a test sound signal output by each of the loudspeakers and detected for each of the plurality of loudspeakers,
determining, for each of the loudspeakers, an operating frequency range based on the determined sound signal response,
assigning a speaker type to each of the loudspeakers based on the determined operating frequency range,
determining, for each of the loudspeakers, a location in the operating environment,
determining a grouping for each of the loudspeakers, by which each loudspeaker is grouped into one of several speaker groups based on the determined location and the speaker type of a corresponding loudspeaker, and
providing the determined grouping for further tuning the sound system.

12. The system of claim 11, wherein the steps further comprise determining the grouping of the loudspeakers such that the loudspeakers arranged relative to each other within a predefined distance in the operating environment are grouped into a same speaker group.

13. The system of claim 11, wherein the sound signal response is determined for each of the loudspeakers separately with the test sound signal being output by only one of the plurality of loudspeakers and detected by the acoustic detector.

14. The system of claim 11, wherein the grouping of the loudspeakers is determined such that the loudspeakers arranged relative to each other within a predefined distance in the operating environment are grouped into a same speaker group.

15. The system of claim 11, wherein the grouping of the loudspeakers is determined such that the loudspeakers belonging to a same speaker group together cover a defined frequency range broader than the operating frequency range of one of the loudspeakers present in the same speaker group.

16. The system of claim 11, wherein the grouping of the loudspeakers is determined such that loudspeakers of a different speaker type are placed in a same speaker group.

17. The system of claim 11, wherein providing the determined grouping comprises at least one of the following:
using the grouping for controlling a phase of at least one input audio signal input into all loudspeakers of one group, or
using the grouping for generating a 3-dimensional sound field based on the plurality of loudspeakers.

18. The system of claim 11, wherein determining the sound signal response comprises determining a total harmonic distortion (THD) signal, wherein the operating frequency range is determined from the THD signal.

19. The system of claim 11, wherein assigning the speaker type comprises comparing the determined operating frequency range to a look up table in which the speaker type is indicated in dependence on the operating frequency range.

20. One or more non-transitory computer-readable media storing instructions that, when executed by one or more processors, cause the one or more processors to perform the steps of:
determining a sound signal response detected by an acoustic detector placed at a defined position within an operating environment where a sound system with a plurality of loudspeakers is located, wherein the sound signal response is based a test sound signal output by each of the loudspeakers and detected for each of the plurality of loudspeakers,
determining, for each of the loudspeakers, an operating frequency range based on the detected sound signal response,
assigning a speaker type to each of the loudspeakers based on the determined operating frequency range,
providing, for each of the loudspeakers, a location in the operating environment,
determining a grouping for each of the loudspeakers, by which each loudspeaker is grouped into one of several speaker groups based on the provided location and the speaker type of a corresponding loudspeaker, and
providing the determined grouping for further tuning the sound system.
